(19) United States
(12) Patent Application Publication
(10) Pub. No.: US 2009/0139973 A1
(43) Pub. Date: Jun. 4, 2009

(54) VEHICLE FLOOR HEATING DEVICE

(76) Inventor: Stephen T. Hung, Grosse Pointe Park, MI (US)

Correspondence Address: VISTEON/BRINKS HOFER GILSON & LIONE, 524 South Main Street, Suite 200, Ann Arbor, MI, 48104, US

(21) Appl. No.: 11/947,480

(22) Filed: Nov. 29, 2007

(51) Int. Cl. B60L 1/00

(52) U.S. Cl. 219/202; 219/528

(57) ABSTRACT

A foot heating device for heating an occupant's feet on the floor of a motor vehicle. The device includes a panel having a bottom surface residing on the floor and a top surface that supports the occupant's feet. The panel also includes and insulating layer, a radiant barrier layer disposed adjacent to the insulating layer and a heating layer disposed between the radiant layer and the top surface. A heater is included in the heater layer. The heater is configured to provide heat for heating the top surface. A lower portion of the panel has a first thermal resistance and an upper portion of the panel has a second thermal resistance. The first thermal resistance being greater than the second thermal resistance.

### BACKGROUND OF THE INVENTION

1. Field of Invention

The invention generally relates to automotive climate control, and, more particularly, to a foot warming device for use on a vehicle floor.

2. Background of the Invention

Many people have difficulties in keeping their feet warm while seated in a vehicle, particularly when cool temperatures at the floor level prevail. Keeping the feet comfortably warm is difficult for a number of reasons, including poor circulation to the feet.

The predominate technology for vehicle footwell or floor heating is the distribution of engine waste heat from the heater core in an HVAC (Heating Ventilating and Air Conditioning) module. One problem with this type of system is that the heater core is cold during cold starting of the vehicle and, accordingly, there is little to no waste heat. Another problem is that, even when the heater core is warm and able to provide waste heat, the metal footwell substructure of the vehicle transfers a significant portion of the heat to air outside of the vehicle during cold weather, via thermal conduction through the metal substructure.

### BRIEF SUMMARY OF THE INVENTION

In overcoming the drawbacks and limitations of the prior art, the present invention provides a new and improved device for heating a vehicle occupant's feet.

In at least one embodiment, the present invention provides a floor based device for heating an occupant's feet. The device includes a panel having a bottom surface that resides on the floor of the vehicle and a top surface that supports the occupant's feet. The panel further includes an insulating layer, which may include or be the bottom surface, a radiant barrier layer disposed adjacent to the insulating layer and a heater layer disposed between the radiant layer and the top surface. The heating layer includes a heater that provides heat to the top surface. A first thermal resistance is defined between the heater and the bottom layer. A second thermal resistance, which is less than the first thermal resistance, is defined between the heater and the top surface of the panel.

In at least one other embodiment of the present invention, the heating layer includes a plurality of channels and portions of the heater are disposed along or within the channels.

Further objects, features and advantages of the invention will become apparent from consideration of the following description and the appended claims when taking in connection with the accompanying drawings.

### BRIEF DESCRIPTION OF THE DRAWINGS

FIG. 1 is a perspective view of a heating device in accordance with an embodiment of the present invention;

FIG. 2 is an exploded perspective view of the heating device seen in FIG. 1;

FIG. 3 is a cross sectional view through a heating device in accordance with an embodiment of the present invention;

FIG. 4 is a cross sectional view through a heating device in accordance with another embodiment of the present invention;

FIG. 5 is a cross sectional view through a heating device in accordance with a further embodiment of the present invention;

FIG. 6 is a cross sectional view through a heating device in accordance with yet another embodiment of the present invention; and

FIG. 7 is a perspective view of a heating device in accordance with another embodiment of the present invention.

### DETAILED DESCRIPTION OF THE INVENTION

Detailed embodiments of the present invention are disclosed herein. It is understood, however, that the disclosed embodiments are merely exemplary of the invention, which may be embodied in various and alternative forms. The figures are not necessarily to scale, some figures may be exaggerated or minimized to show the details of a particular component. Therefore, specific structural and functional details disclosed herein are not to be interpreted as limiting, but merely as a representative basis for the claims and for teaching one skilled in the art to practice the present invention.

The present invention seeks to overcome some of the problems associated with heating a person's feet in a motor vehicle, including the problems associated with directing cold air from the HVAC module towards the occupant's feet.

Applying the principles of the present invention, a heating device is provided that rests on the vehicle floor and heats the occupant's feet. The heating device comprises a panel which includes a heating portion or heater. The heater is disposed within the panel and provides heat for heating the top surface of the device, where the occupant's feet are supported. Heat provided by the heater may, for example, come from heating elements disposed within the heater or from air that is heated prior to being received by the panel.

The panel has a lower portion and an upper portion. The lower portion is defined between the bottom surface of the panel and the heater. The upper portion is defined between the heater and the top surface of the panel. Both the upper and lower portions of the panel have a respective thermal resistance. That is, the corresponding thickness of the portion divided by the corresponding thermal conductivity of the portion defines each portion's thermal resistance. A relatively high value for thermal resistance corresponds to a portion having high thermal insulative properties. Conversely, a relatively low value for thermal resistance corresponds to a portion having low thermal insulative properties or hence, high thermal conductive properties.

The panel is constructed such that the lower portion has a higher thermal resistance than the upper portion. This construction provides a thermal gradient bias for transferring heat from the heater upwards towards the top surface of the panel. The greater the thermal resistance of the lower portion is relative to the thermal resistance of the upper portion, the more thermally isolated the panel becomes from the floor of the vehicle. During cold weather, the metal of the footwell substructure is cold and transfers heat quickly to outside the vehicle. This results in significant heat loss. However, by thermally isolating the panel from the footwell, less heat is lost through the floor, while more heat is directed towards the occupant's feet on the top surface of the device.

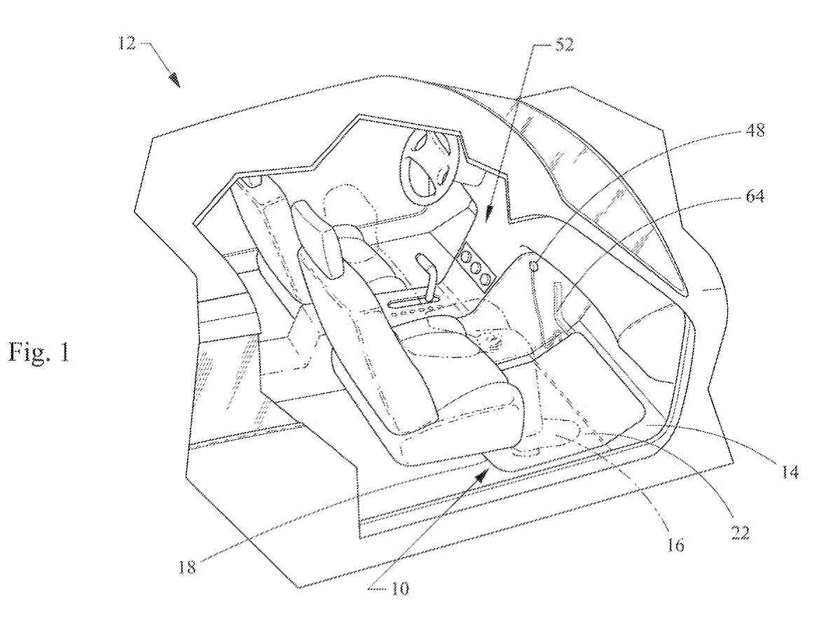

Referring now to the drawings, FIG. 1 generally illustrates a heating device 10 for a vehicle 12, as embodied by the present invention. The heating device 10 is located on a floor 14 of the vehicle 12 and supports an occupant's feet 16, while also providing heat to the occupant's feet 16.

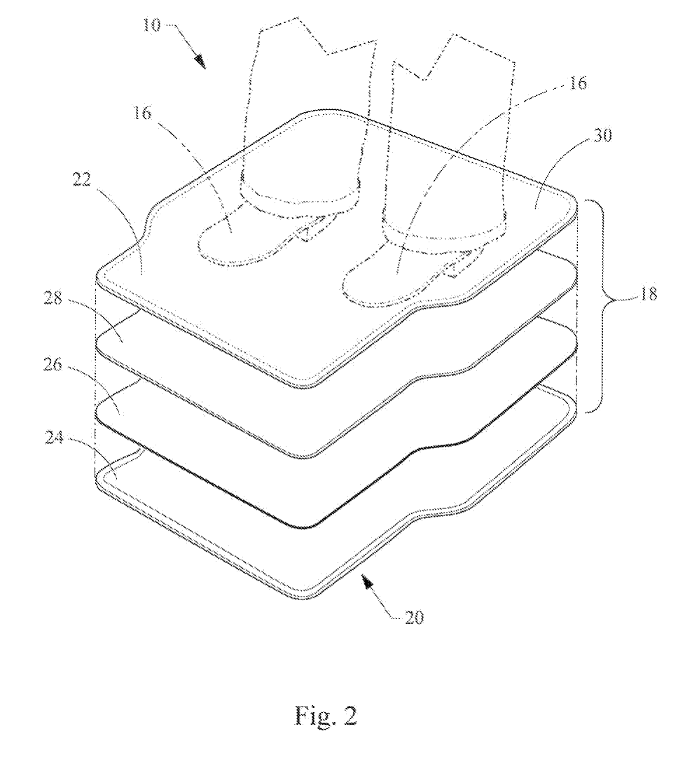

The device 10, as seen in FIG. 2, includes a panel 18 having a bottom surface 20 that rests on the floor 14 of the vehicle 12. The panel 18 also has a top surface 22 on which the occupant's feet 16 with reside. Between the top and bottom surfaces 20, 22, the panel 18 includes an insulating layer 24, a radiant barrier layer 26 and a heating layer 28. The bottom surface 20 may be a surface of the insulating layer 24, or another layer. The radiant barrier layer 26 is disposed adjacent to the insulating layer 24. The heating layer 28 is disposed between the radiant barrier layer 26 and the top surface 22 of the device 10. While the top surface 22 may be a surface of the heating layer 28, this surface 22 may optimally be part of a decorative layer 30 provided over the heating layer 28.

Preferably, the decorative layer 30 is thin and disposed immediately adjacent to the heating layer 28. The decorative layer 30 may be for example, carpet, wood veneer or any other suitable decorative material that is, preferably, more thermally conductive than the insulating layer 24.

Referring to FIGS. 2-6, various embodiments of the device 10 are illustrated therein and like elements are being designated. In each embodiment, the insulating layer 24 provides thermal insulation from the floor 14. The insulating layer 24 may be made, for example, from a low thermally conductive plastic material such as polypropylene (PP) or high density polyethylene (HDPE). In one construction, the device may have as the insulating layer 24 a 2.5 mm thick layer of PP with a thermal conductivity of about 0.0023 J/(cm*sec*deg C) to provide a thermal resistance of about 100 (cm̂2*Sec*deg C)/J. Alternatively, the insulating layer 24 may have a composite structure where two or more materials, each having preferably low thermal conductivity, comprise the layer 24. For example, the insulating layer 24 may be made from co-extruded plastic sheet that includes two or more different plastic materials. On the other hand, the insulating layer 24 may be made from a polymeric material including pockets (e.g. foam) or other volumes that contain air. Air, having a thermal conductivity of about 0.00026 J/(cm*sec*deg C), provides excellent insulative properties to the layer 24. Other suitable materials with relatively low thermal conductivity, which are known in the art, may also be used.

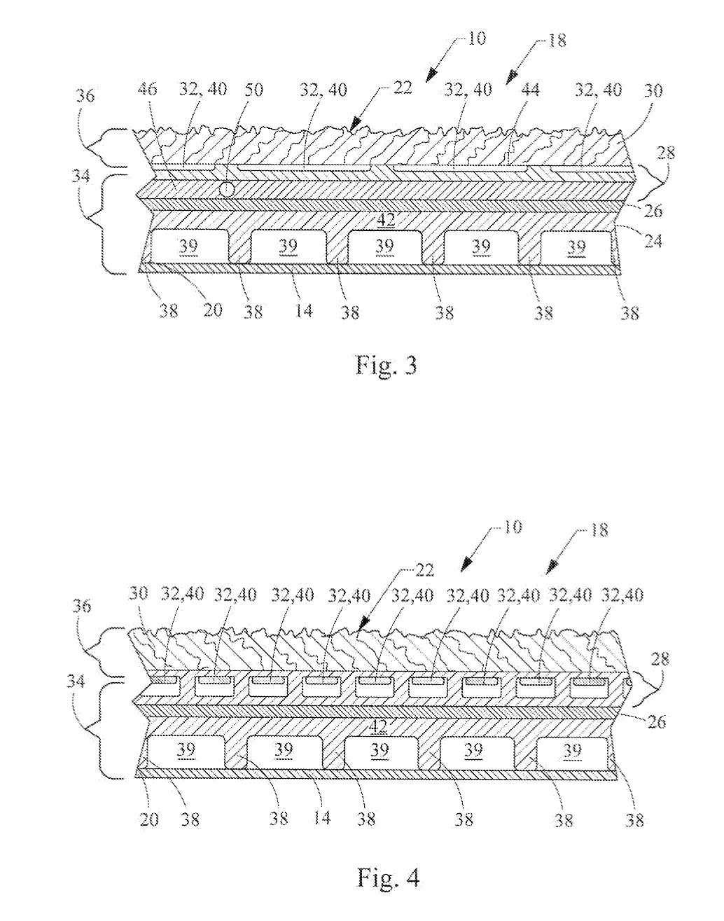

The insulating layer 24 may further include a rib arrangement (see FIGS. 3-6) for supporting the panel 18 on the floor 14. The rib arrangement, having an open volume 39 defined between each pair of ribs 38 and containing air, has a relatively high thermal resistance that enhances thermal isolation of the panel 18 from the floor 14. In one illustrative construction, the insulating layer is made from PP, has a solid top portion 42 that is about 1-1.5 mm thick and from which extend ribs 38 that are about 5-7 mm tall by 1-1.5 mm thick and spaced about 7-10 mm apart. The insulating layer 24 in this arrangement has a thermal resistance of at least about 1700 (cm̂2*Sec*deg C)/J.

The insulating layer 24 may further include protrusions (not shown) for gripping the floor 14 that are disposed along the bottom surface 20. For example, if the floor 14 of the vehicle 12 is covered with carpet, the protrusions may be small nibs that penetrate into the pile of the carpet to provide a mechanical interlock that impedes side to side movement of the panel 18. Other known mechanisms for retaining floor panels could also be employed.

The radiant barrier layer 26 is provided so as to reflect radiant heat towards the top surface 22. The radiant barrier layer 26 is preferably made from a low emissivity material, which may be thin and flexible, such as a metal foil or a metallized polymer film or sheet. Other suitable thermally reflective materials may also be used. Moreover, the radiant barrier layer 26 may include openings to allow for direct bonding or attachment of the insulating layer 24 to the heating layer 28.

The heating layer 28 includes a heater 32, disposed within the heating layer 28 that is configured to provide heat for heating the top surface 22.

As illustrated in FIGS. 3, 4 and 6, the heater 32 includes heating elements 40 for providing heat. The heating elements 40 may be, for example, electrical resistance heating elements or a heating foil. In one embodiment and as illustrated in FIG. 3, the heating layer 28 has heating elements 40 bonded to a thin upper sub-layer 44. The thin upper sub-layer 44 of the heating layer 28 may be a plastic film, such as polyethyleneterepthalate (PET) or polyethyleneisopthalate (PEI), which has excellent temperature stability. Other suitable temperature stable materials known in the art may also be used. The thin upper sub-layer 44 may further be bonded, preferably to form a seal, to a lower sub-layer 46 of the heating layer 28. The lower sub-layer 46 may be, for example, a PP sheet. Alternatively, the upper sub-layer 44 of the heating layer 28 may be bonded to the radiant barrier layer 26 which, for example, may have the form of a metallized plastic sheet.

The device 10 may further include an ON-OFF switch 47 (provided on the instrument panel of the vehicle 12) electrically coupled to the power supply 48 of the vehicle 12 and to the heater 32 to form an electrical circuit. The panel 18 may also include a thermostat 50 or a positive temperature coefficient device, which is electrically coupled to the circuit and which controls the heating elements 40 to within a predetermined temperature range. Alternatively, the heating elements 40 may be positive temperature coefficient thermister heaters, which are self regulating to within a temperature range. Other suitable heating elements know in the art may also be used.

The construction of the panel 18 defines a lower portion 34, extending from beneath the heater 32 and includes the bottom surface 20. This lower portion 34 has a first thermal resistance. An upper portion 36 of the panel 18, extending from the heating portion 32 to and including the top surface 22 of the panel 18, has a second thermal resistance. The thermal resistance of the lower portion 34 is greater than the thermal resistance of the upper portion 36 for the reasons previously discussed. In at least one embodiment, the thermal resistance of the upper portion 36 is less than about 100 (cm̂2*Sec*deg C)/J. In another embodiment, the ratio of the first thermal resistance to the second thermal resistance is at least about 5 to 1 and in a preferred embodiment the ratio is at least about 17 to 1.

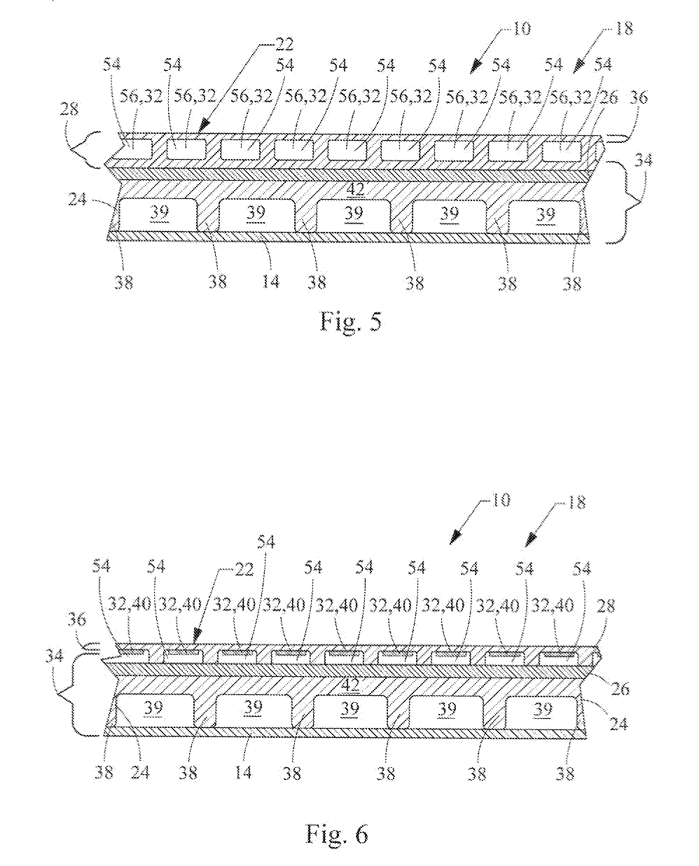

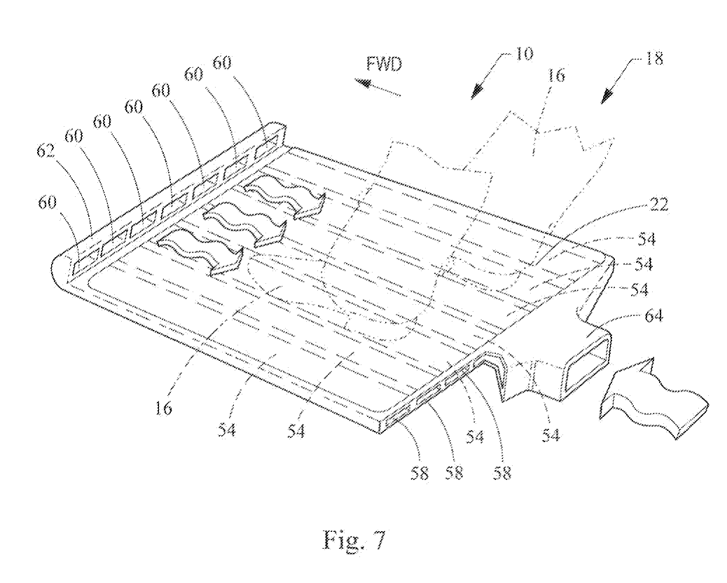

Referring to FIGS. 4-7, the heater 32 may be configured as including channels 54 to receive and pass air through the heating layer 28 so as to provide heat to the top surface 22 by conduction through the panel 18 and/or forced convection directed at the occupant's feet positioned on the top surface 22. The air may be heated prior to being received, as in FIG. 5, or the air may be heated as it is advanced through the channels 54 and along the heating elements 40, wherein both the channels and heating element are disposed within the heating layer 28. In at least one embodiment, the heating layer 28 is in fluid communication with the HVAC system 52 (Shown in FIG. 1) of a vehicle 12. In such a construction, the heating layer 28 advances air received from the HVAC system 52 along the channels 54 of the heater 32 and may discharge the heated air directly towards the occupant's feet 16 (Shown in FIG. 7). Whenever so provided, the channels 54 have inlet ends 58 that receive the air from the HVAC system 52 and discharging ends 60 that dispense the air. The panel 18 may further include a deflector 62 proximate the discharging ends 60 and positioned such that the dispensing air is directed towards the occupant's feet 16.

Referring to FIG. 6, the channels 54 of the heating layer 28 may be open at the bottom such that the radiant barrier layer 26 is exposed to the channels 54 and directly reflects radiant heat back towards the top surface 22. This arrangement is suitable both for when the heating elements 40 are disposed within the heating portion 32 or when feed air is heated prior to being received by the panel 18. Alternatively, the bottom of the channels 54 may themselves be metallized to form the radiate barrier layer 26 therein.

A duct 64 interfacing with the HVAC system 52 and the heating layer 28 provides fluid communication between the HVAC system 52 and the heating layer 28. In one possible construction, the duct 64 may have heating elements disposed within the internal flow volume of the duct 64. These heating elements may be of the type previously discussed and be electrically coupled to an HVAC controller (not shown) that controls the HVAC system 52, and the vehicle power supply 48 to form an electrical circuit. When cool air from the HVAC system 54 is received within the duct 64, as may occur for example during a cold start of the vehicle 11, the positive temperature coefficient thermister heaters cooperating with the controller, quickly warms the air to within a given temperature range. When warm air from the HVAC system 52 is subsequently received within the duct 64, the heaters would not heat the air. The warm air is thereafter received by the heating layer 28 so as to heat the top surface 22 of the panel 18.

As a person skilled in the art will readily appreciate, the above description is meant as an illustration of implementation of the principles of this invention. This description is not intended to limit the scope or application of this invention and that the invention is susceptible to modification, variation and change, without departing from the spirit of the invention, as defined in the following claims.

1. A foot heating device for a vehicle, the device comprising:
a panel having a bottom surface for positioning on the floor of the vehicle, the panel also having a top surface for supporting the feet of an occupant of the vehicle, the panel further including:
an insulating layer;
a radiant barrier layer disposed adjacent to the insulating layer; and
a heating layer disposed between the radiant barrier layer and the top surface, the heating layer including a heater disposed therein, the heater providing heat for heating the top surface;
a lower portion of the panel is defined between the heater and the bottom surface of the panel and has a first thermal resistance, an upper portion of the panel is defined between the heater and the top surface of the panel has a second thermal resistance, wherein the first thermal resistance is greater than the second thermal resistance.

2. The device according to claim 1 wherein a ratio of the first thermal resistance to the second thermal resistance is at least about 5:1.

3. The device according to claim 1 wherein the panel further includes a decorative layer provided over the heating layer, the decorative layer including the top surface.

4. The device according to claim 1 wherein the insulating layer includes the bottom surface.

5. The device according to claim 1 wherein the insulating layer includes a plurality of spaced apart ribs extending from a base layer generally toward the floor of the vehicle.

6. The device according to claim 1 further comprising an ON-OFF switch electrically coupled to a power supply of the vehicle and the to the heater to form an electrical circuit.

7. The device according to claim 6 wherein the heater includes electrical resistance heating elements that provide heat and the panel further includes one of a thermostat and a positive temperature coefficient device, which is electrically coupled to the electrical circuit and controls the heating portion to within a temperature range.

8. The device according to claim 6 wherein the heater includes positive temperature coefficient thermistor heaters for providing heat which are self-regulating to within a temperature range.

9. The device according to claim 1 wherein the heating layer is in fluid communication with an HVAC system of the vehicle and is configured to advance air received from the HVAC system along the heating portion and to dispense the air directed towards the occupant's feet.

10. The device according to claim 9 wherein the heating layer further includes a plurality of channels juxtaposed within the heating layer, the channels having each a receiving end that receives the air from the HVAC system and a dispensing end that dispenses the air.

11. The device according to claim 10 wherein the panel further includes a deflector proximate to the dispensing ends and positioned such that the dispensing air is directed towards the occupant's feet.

12. The device according to claim 10 wherein heating elements are provided within the channels.

13. The device according to claim 9 further including a duct that provides fluid communication between the HVAC system and the heating layer.

14. The device according to claim 13 further including positive temperature coefficient thermistor heaters disposed within the duct, the positive temperature coefficient thermistor heaters being electrically coupled to a HVAC controller that controls the HVAC system and to a vehicle power supply to form an electrical circuit such that when cool air from the HVAC system is received within the duct the positive temperature coefficient thermistor heaters heat the air and when warm air from the HVAC system is received within the duct the positive temperature coefficient thermistor heaters do not substantially heat the air.

15. A foot heating device for a vehicle floor, the device comprising:
a panel having a bottom surface for positioning on the floor of the vehicle, the panels also including a top surface for supporting the feet of an occupant of the vehicle, the panel including:
an insulating layer;
a radiant barrier layer disposed adjacent to the insulating layer; and
a heating layer disposed between the radiant barrier layer and the top surface, the heating layer including a heater comprised of a plurality of channels with the heating layer, the heating layer being disposed along the channels and configured to provide heat for heating the top surface;
a lower portion of the panel is defined between the heater and bottom surface of the panel and has a first thermal resistance; and
an upper portion of the panel is defined between the heater and the top surface of the panel and has a second thermal resistance, wherein the first thermal resistance is greater than the second thermal resistance.

16. The device according to claim 15 wherein the channels are in fluid communication with an HVAC system of the vehicle and have a receiving end that receives air from the HVAC system, and a dispensing end configured to dispense the air towards the occupant's feet.

17. The device according to claim 15 further comprising heating elements located within the channels and an ON-OFF switch that is electrically coupled to a power supply of the vehicle and the heating elements to form an electrical circuit, the panel further including one of a thermostat and a positive temperature coefficient device, which is electrically coupled to the electrical circuit and controls the heating elements to within a temperature range.

18. The device according to claim 15 further comprising heating elements located within the channels and an ON-OFF switch that is electrically coupled to a power supply of the vehicle and the heating elements to form an electrical circuit, the heating elements including positive temperature coefficient thermistor heaters for providing heat which is self-regulating to within a temperature range.

19. The device according to claim 15 wherein a ratio of the first thermal resistance to the second thermal resistance is at least about 5:1.

20. The device according to claim 15 further including a duct and positive temperature coefficient thermistor heaters disposed within the duct, the duct providing fluid communication between the HVAC system and the channels, the positive temperature coefficient thermistor heaters being electrically coupled to a HVAC controller that controls the HVAC system and a vehicle power supply to form an electrical circuit such that when cool air from the HVAC system is received within the duct the positive temperature coefficient thermistor heaters heat the air to within a temperature range and when warm air from the HVAC system is received within the duct the positive temperature coefficient thermistor heaters do not substantially heat the air.
